(19) United States
(12) Patent Application Publication
(10) Pub. No.: US 2006/0167841 A1
(43) Pub. Date: Jul. 27, 2006

(54) Method and system for a unique naming scheme for content management systems

(75) Inventors: Ronald Campbell Allan, Austin, TX (US); Anmol Neelammna Matada, Round Rock, TX (US); Christopher N. Vaughan, Cedar Park, TX (US)

Correspondence Address: Greg Goshorn, P.C., 9600 Escarpment, auite 745-9, AUSTIN, TX, 78749, US

(73) Assignee: INTERNATIONAL BUSINESS MACHINES CORPORATION, ARMONK, NY (US)

(21) Appl. No.: 10/992,518

(22) Filed: Nov. 18, 2004

(51) Int. Cl. G06F 17/30

(52) U.S. Cl. 707/3

(57) ABSTRACT

Provided is a method for unique naming for a content management system, including several steps. A first request including a relative URI and request-specific information is received. A second request including a long URI including the relative URI and the request-specific information is created. The second request is sent.

### TECHNICAL FIELD

The present invention relates generally to resource identification and, more specifically, to a method and system for a unique naming scheme for content management systems.

### BACKGROUND OF THE INVENTION

International Business Machines Corp. (IBM) of Armonk, N.Y. has been at the forefront of new paradigms in business computing. As the importance of networking has grown over the last few decades, the increasing number of resources available to users has created increasing utilization problems. If a user cannot conveniently utilize a resource, the fact that it exists and would theoretically be useful provides absolutely no practical benefit to the user.

As a result, content management systems have utilized various approaches in response to the problem of conveniently utilizing resources. Identification schemes have had to balance two characteristics important to convenient resource identification: user friendliness and avoidance of ambiguity. For example, two approaches to naming resources are “common naming” and “abstract naming.” Common names are familiar to users, but are likely to be ambiguous beyond a small namespace. For example, identifying a person by his given name would be user friendly and unambiguous within a namespace containing only one person bearing the given name, but the approach would be problematic in a larger namespace containing many people bearing the given name because an unacceptable level of ambiguity would be introduced.

Abstract names are typically unfamiliar to users but have the advantage of being unambiguous. For example, identifying a person by his full name, time and place of birth, and parents' full names identifies him in a fairly unambiguous fashion. However, such an approach is user unfriendly due to the unwieldy nature of the resulting identifiers.

The system of uniform resource identifiers (URIs) is an example of abstract naming. URIs are utilized to uniquely identify resources, two examples of which are files and objects. It is often the case that, within a limited namespace, users identify resources using “relative URIs” which can improve user friendliness at the cost of potentially introducing ambiguity as the namespace changes over time.

What is clearly needed is a naming scheme for content management systems which enables unique identification of resources in a user-friendly manner within a changing namespace.

### SUMMARY OF THE INVENTION

Provided is a method for unique naming for a content management system, including several steps. A first request including a relative URI and request-specific information is received. A second request including a long URI including the relative URI and the request-specific information is created. The second request is sent.

Also provided is a method for unambiguously identifying and providing resources in response to requests including a relative identifier including several steps. A request including a relative uniform resource identifier (URI) and request-specific information is received by a server. A long URI including the relative URI and the request-specific information is created by the server. The long URI is compared to a plurality of resources by the server. One of the plurality of resources is selected by the server for provision in response to the request, based on the comparison.

Also provided is a content management system for unambiguously identifying and providing resources in response to requests including a relative identifier. The system includes a server and computer-readable instructions. The server includes a computing device. The computer-readable instructions are executable on the computing device, and, when executed, perform a process including several steps. A message including a relative URI and message-specific information is received. A long URI including the relative URI and the message-specific information is provided. The long URI is compared to a plurality of resources, and one of the plurality of resources is selected based on the comparison.

Also provided is a method for creating and identifying a plurality of unambiguously identified resources based on an initial resource, including several steps. An initial resource including a relative URI is received by a computing device. The initial resource is converted into at least one final resource comprising at least one of the group of a MIME type, a user agent identifier, and a user locale. A URI is created for each of the at least one final resources based on at least the relative URI and the at least one of the group of a MIME type, a user agent identifier, and a user locale.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram showing translation of a relative uniform resource identifier (URI) into a long URI, according to an embodiment of the present invention;

FIG. 2 is a block diagram showing provision of one of a plurality of resources in response to a user request for a resource identified with a relative URI, according to an embodiment of the present invention;

FIG. 3 is a block diagram showing a content management system enabling the use of relative URIs at the user interface level and long URIs throughout the backend, according to an embodiment of the present invention; and

FIG. 4 is a block diagram showing creation and identification of resources based on an initial resource bearing an at-least-relative URI, according to an embodiment of the present invention.

### DETAILED DESCRIPTION OF THE FIGURES

Although described with particular reference to a content management system, the claimed subject matter can be implemented in any information technology (IT) system in which a user-friendly unique naming scheme is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

Content management systems have been developed and implemented to facilitate the use of network-available content in the face of ever-growing network size and interconnectivity. Networking can be understood through a variety of conceptual frameworks, one of which is the Open System Interconnection (OSI) Reference Model. The OSI Reference Model provides a framework describing how networking technologies functionally coordinate, includes seven layers, among which networking technologies are allocated:

OSI Layers

| | |
|---|---|
| 7 | Application |
| 6 | Presentation |
| 5 | Session |
| 4 | Transport |
| 3 | Network |
| 2 | Data Link |
| 1 | Physical |

Layers 1-4 can be referred to as “the lower layers” and are essentially directed to formatting, encoding and transmission of data over a network, i.e., moving data around a network, and are typically implemented with a combination of hardware and software. Layers 5-7 can be referred to as “the upper layers” and are essentially directed to interacting with users and implementing applications, protocols and services that run over the network, and are typically implemented in software. As discussed above, and as those skilled in the art will appreciate, specific design considerations can make it advantageous to use a hardware implementation where a software implementation would more commonly be used, and vice-versa. Such modifications and variations may depart from the literal description provided in this document while remaining within the spirit and scope of the appended claims.

The layers have been demarcated to support a conceptual framework, but in practice the layers functionally interconnect. For instance, Ethernet specifications are concerned with both layers 1 and 2, and TCP and IP in the TCP/IP protocol suite are concerned with both layers 3 and 4.

The preferred embodiment of the present invention is directed to the upper layers. In practice, separation of the upper layers is not as clear separation of the lower layers. For example, the architecture of the TCP/IP protocol suite treats layers 5-7 as a single “top layer.” A consequence of this is that the top layer does not provide services to a higher OSI layer, but to programs and users who wish to utilize the network. Stated differently, the top layer implements functions needed by network users. The services of lower layers are utilized as needed to support the top layer functions.

For example, consider web browser software operating on a personal computer. While the web browser software is conventionally referred to by users as an application, it does not reside at the OSI application layer. Rather, the web browser software utilizes the functions provided by the application layer, such as hypertext transfer protocol (HTTP). In a sense, the web browser software could be said to reside at an “eighth” OSI layer.

For many purposes, layers 5-7 are not well-separated and are therefore subject to a conceptual blurring. Accordingly, layers 5-7 are sometimes demarcated using an alternate framework, as shown in the following table:

OSI Layers 5-7

| Functional Area | Example(s) |
|---|---|
| Naming systems | TCP/IP Domain Name System |
| File and resource sharing | Network File System |
| protocols | |
| Network configuration and | Host configuration protocols BOOTP and |
| management protocols | DHCP |
| End-user applications and | General file transfer, electronic mail, |
| application protocols | Usenet, the World Wide Web, interactive |
| | protocols (such as Telnet) and |
| | administration utilities |

The preferred embodiment of the present invention relates especially to the fourth functional area presented in the above table: End-user applications and application protocols. Within this functional area, the preferred embodiment relates especially to a universal system established for use by TCP/IP applications in addressing Internet resources: uniform resource identifiers (URIs).

The URI system was created to improve the usability of the massive amount of information available by virtue of the fact that the Internet includes millions of interconnected servers. Each URI uniquely identifies how a client can locate and access a particular resource so that it can be used. URIs enable what has been referred to as “application layer addressing.” This differs from layer 2 MAC addressing, layer 3 IP addressing, layer 4 ports and sockets addressing, and the Domain Name System (DNS) addressing. In particular, DNS names identify specific real or virtual devices connected to a network. A URI builds on a DNS name to identify a particular file, object, or other resource logically related to the device identified by the DNS name. In practice, a URI consists of a single fairly compact string all of the information necessary to refer to a resource. Because URIs are compact strings, they are easy to embed in documents, thereby enabling the convenient embedding of links from the document to any resources external to itself which are at least theoretically directly or indirectly reachable.

Every URI falls into one of two subcategories: uniform resource locators (URLs) and uniform resource names (URNs). A URL is a URI that specifies a protocol or mechanism for accessing the target resource and the location of the target resource. An example of a URL is http://www.ibm.com/us/, which identifies a web page provided by International Business Machines, Inc. This URL specifies the web page's protocol or access mechanism as HTTP and specifies the web page's location by DNS domain name “www.ibm.com” and path “us/”.

By contrast, a URN is a URI that provides a resource with a unique name without specifying the resource's access mechanism or location. An example of a URN is URN:isbn:0471414638, which identifies a book entitled, “The Maverick and His Machine: Thomas Watson, Sr. and the Making of IBM” by Kevin Maney, published Apr. 4, 2003 in paperback form by Wiley (John Wiley & Sons, Inc.). Thus the URI uniquely identifies the book, but does not identify where or how it can be accessed.

Both URLs and URNs have limitations, but each provides a form of URI which uniquely identifies resources. In current practice, most URIs are HTTP URLs following standard Web URL syntax rules. Therefore, the majority of this document will use examples and terminology appropriate for Web URL syntax rules in order to illustrate the preferred embodiment of the present invention. However, as will be understood by those skilled in the art, other URIs are within the spirit and scope of the appended claims.

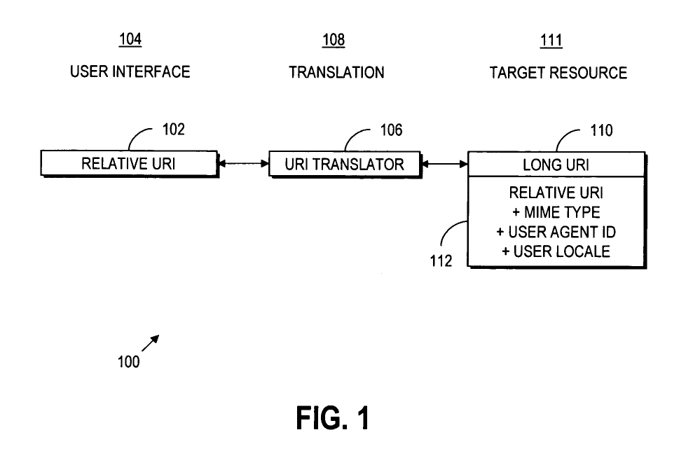

Turning now to the figures, FIG. 1 is a block diagram showing a process 100 for translating a relative URI into a long URI, according to an embodiment of the present invention. A relative URI 102 is used at a user interface level 104. The relative URI 102 is passed to a URI translator 106 to undergo translation 108. The URI translator 106 outputs a long URI 110 identifying a target resource 111, which is likely a resource which was intended to be identified by the relative URI 102 at the user interface level 104. The long URI 110 is based on the relative URI 102 as well as context information 112, preferably related to the user and the target resource 111.

The context information 112 included as part of the long URI 110 preferably includes a multipurpose internet mail extension (MIME) type, a user agent identifier (user agent ID), and a user locale. Among other aspects, the user locale preferably includes a user country and a user language.

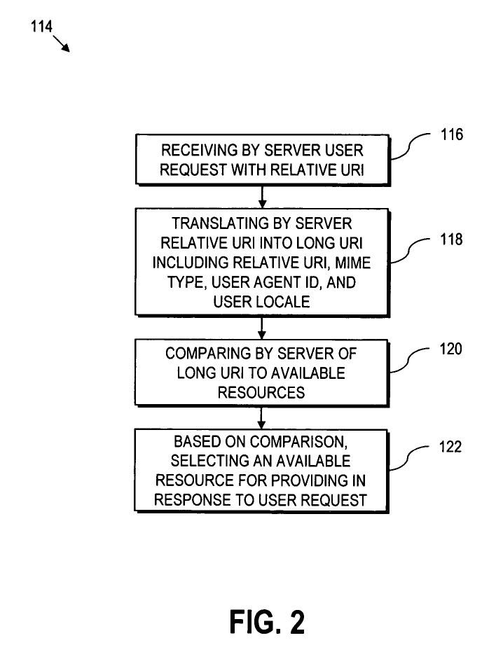

FIG. 2 is a block diagram showing a process 114 for providing one of a plurality of resources in response to a user request for a resource identified with a relative URI, according to an embodiment of the present invention. A user request with a relative URI is received 116 by a server. The relative URI is translated 118 by a server into a long URI which includes the relative URI and context information comprising a MIME type, a user agent ID, and a user locale. The long URI is compared 120 by the server to a plurality of available resources. Based on the comparison, one of the plurality of available resources is selected 122 for providing in response to the user request.

Throughout this document, the term “user agent ID” means user's computing environment relevant to accessing the resource in question. For example, if the resource is a web page, then the user agent ID could include the user's web browser software and computing device (e.g., personal digital assistant, personal computer, printer, etc.). This would allow the user to request a resource using a relative URI and, by virtue of behind-the-scenes translation of the relative URI to a long URI, be provided with a resource customized to the user.

For example, the user requests the relative URI http://www.someserver.com from a server. The user's request includes header information indicating that the user is in the United States and using a web browser that reads HTML. Accordingly, the server translates the relative URI into the long URI http://www.someserver.com/text/html/a/us/en/home.html so that the user will be provided with a web page specifically designed for users in the United States using web browsers that read HTML. The long URI is broken apart as shown in the following table:

TABLE
Long URI Example

| | |
|---|---|
| Web URL | http://www.someserver.com |
| MIME type | text/html |
| User agent ID | a |
| User locale | us/en |
| Resource filename | home.html |

In the Long URI Example table, the token “text/html” indicates that the format of the resource is suitable for web browsers which read HTML. The token “a” indicates by design that the web browser is capable of handling DHTML and the functionality of Mozilla 4/x. The token “us” indicates that the user's country is the United States. The token “en” indicates that the user's language is English. The token “home.html” is the mapped home page for requests of type “/” which appended the DNS domain name www.someserver.com.

As this example illustrates, a favored name, such as “home,” can be used across many resources where each resource is tailored to a specific user context and identified behind-the-scenes by an context-sensitive “long URI.”

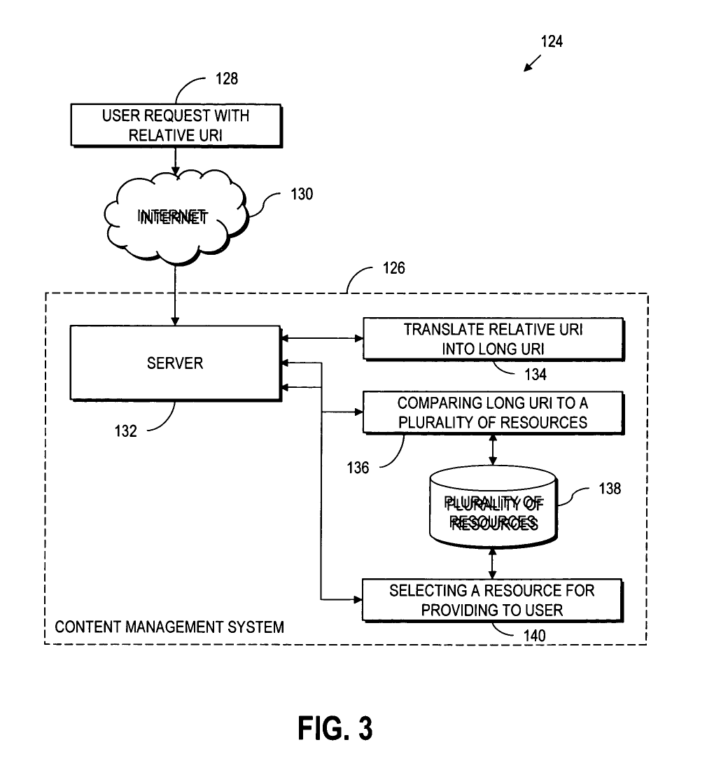

FIG. 3 is a block diagram showing an interconnected network 124 including a content management system 126 enabling the use of relative URIs at the user interface level and long URIs throughout the backend, according to an embodiment of the present invention. A user request with a relative URI 128 is transmitted via the Internet 130 to a server 132 which is part of the content management system 126. The server 132 translates 134 the relative URI into a long URI, compares 136 the long URI with a plurality of available resources 138, and selects 140 one of the plurality of available resources 138 for providing to the user in response to the user request 128 based on the comparison 136.

The content management system 126 effectively hides the details of the disclosed unique naming scheme from the user so that the user is able to use relative URIs, which are more user friendly than long URIs.

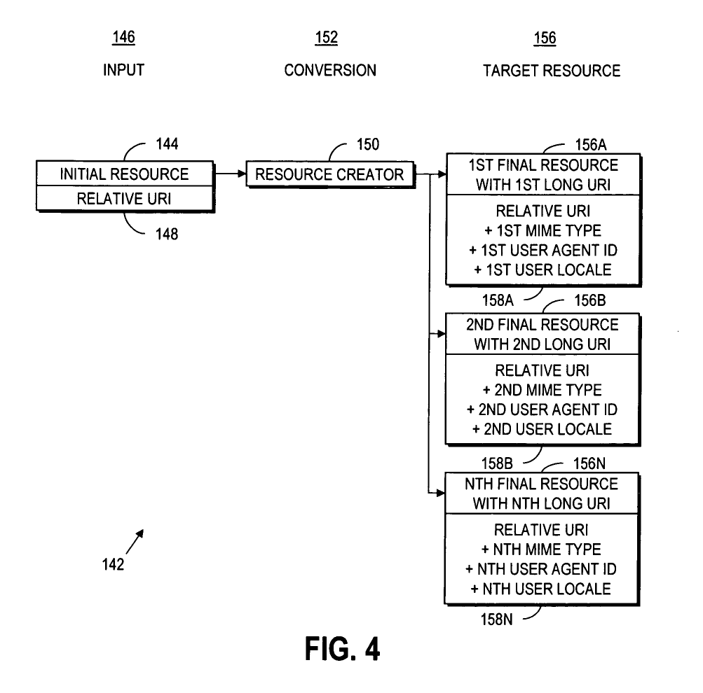

FIG. 4 is a block diagram showing a process 142 for creation and identification of resources based on an initial resource bearing an at-least-relative URI, according to an embodiment of the present invention. An initial resource 144 at an input phase 146 includes a relative URI 148. The initial resource 144 is provided to a resource creator 150 for a creation phase 152. The creation phase 152 is followed by a target resource phase 154 in which the resource creator 150 outputs one or more final resources 156, each having a long URI based on the relative URI and context information 158 preferably related to the target resource and its intended users.

This type of system is especially useful where an initial resource is in a format especially well suited to describing base content. An example of such a format is XML. For example, an initial resource, somecontent.xml, has been created. It is desired that the initial resource be stored as four final resources, each having a different one of four formats: (1) HTML for web browsers capable of handling DHTML and the functionality of Mozilla 4/x for users in the United States using the English language, (2) PDF for web browsers capable of handling DHTML and the functionality of Mozilla 4/x for users in Japan using Japanese, (3) HTML for web browsers capable of handling DHTML and the functionality of Mozilla 4/x except without top and bottom banners and navigational information for users in the United States using the English language, and (4) XML for users in the United States using the English language. A process such as that described in FIG. 4, converts somecontent.xml into the following four resources:

(1) /text/html/a/us/en/somecontent.html;

(2) /application/pdf/a/jp/ja/somecontent.pdf;

(3) /text/html/fast/us/en/somecontent.html; and

(4) /application/xml/a/us/en/somecontent.html.

The result of this example is that each of the four final resources are unambiguously identified. Furthermore, the final resources are named and located so that in response to a user request for “somecontent,” one of the four resources can be selected for provision based on the user context information accompanying the user request.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order. For example, the relative identifier can be converted or translated locally on the user's computing device, then a request containing the full identifier submitted to the application layer or equivalent service.

We claim:

1. A method for unique naming for a content management system, comprising the steps of:
receiving a first request including:
a relative uniform resource identifier (URI); and
request-specific information;
creating a second request including:
a long URI including:
the relative URI; and
the request-specific information;
sending the second request.

2. The method of claim 1, wherein the step of receiving comprises:
receiving the first request including:
the relative URI; and
the request-specific information including at least one of the group of a multipurpose internet mail extension (MIME) type, a user agent identifier, and a user locale.

3. The method of claim 1, wherein the step of receiving comprises:
receiving the first request including:
the relative URI; and
the request-specific information including at least two of the group of a MIME type, a user agent identifier, and a user locale.

4. The method of claim 1, wherein the step of receiving comprises:
receiving the first request including:
the relative URI; and
the request-specific information including:
a MIME type;
a user agent identifier; and
a user locale.

5. The method of claim 1, wherein the step of sending comprises the steps of:
processing the second request; and
sending a response including the resource identified by the long URI in response to the first request.

6. A method for unambiguously identifying and providing resources in response to requests including a relative identifier, comprising the steps of:
receiving by a server a request including:
a relative uniform resource identifier (URI); and
request-specific information;
creating by the server a long URI including:
the relative URI; and
the request-specific information;
comparing by the server the long URI to a plurality of resources; and
selecting by the server one of the plurality of resources, for provision in response to the request, based on the step of comparing.

7. The method of claim 6, further comprising:
sending by the server in response to the request, a response including the one of the plurality of resources.

8. The method of claim 7,
wherein the step of receiving comprises the step of receiving by the server via a full time public network the request including:
the relative uniform resource identifier (URI); and
the request-specific information;
wherein the step of sending comprises the step of sending by the server via the full time public network in response to the request, a response including the one of the plurality of resources.

9. The method of claim 6, wherein the step of receiving comprises the step of:
receiving by the server the request including:
the relative URI; and
the request-specific information including at least one of the group of a MIME type, a user agent identifier, and a user locale.

10. The method of claim 6, wherein the step of receiving comprises the step of:
receiving by the server the request including:
the relative URI; and
the request-specific information including at least two of the group of a MIME type, a user agent identifier, and a user locale.

11. The method of claim 6, wherein the step of receiving comprises the step of:
receiving by the server the request including:
the relative URI; and
the request-specific information including:
a MIME type;
a user agent identifier; and
a user locale.

12. A content management system for unambiguously identifying and providing resources in response to requests including a relative identifier, comprising:
a server including a computing device;
computer-readable instructions executable on the computing device, which when executed perform a process comprising the steps of:
receiving a message including:
a relative uniform resource identifier (URI);
message-specific information;
providing a long URI including:
the relative uniform resource identifier (URI);
the message-specific information;
comparing the long URI to a plurality of resources; and
selecting one of the plurality of resources based on the step of comparing.

13. The content management system of claim 12, further comprising:
further computer-readable instructions executable on the computing device, which when executed perform the process further comprising the step of:
sending in response to the message, another message including the one of the plurality of resources.

14. The content management system of claim 13,
wherein the server is connectible to a full time public network;
wherein the step of receiving comprises the step of receiving via the full time public network the message including:
the relative URI;
the message-specific information;
wherein the step of sending comprises the step of sending via the full time public network in response to the message, another message including the one of the plurality of resources.

15. The content management system of claim 12, wherein the step of receiving comprises the step of:
receiving a message including:
the relative URI;
the message-specific information including at least one of the group of a MIME type, a user agent identifier, and a user locale.

16. The content management system of claim 12, wherein the step of receiving comprises the step of:
receiving a message including:
the relative URI;
the message-specific information including at least two of the group of a MIME type, a user agent identifier, and a user locale.

17. The content management system of claim 12, wherein the step of receiving comprises the step of:
receiving a message including:
the relative URI;
the message-specific information including:
a MIME type;
a user agent identifier; and
a user locale.

18. The content management system of claim 12, wherein the message comprises a user request.

19. The content management system of claim 12, wherein the plurality of resources are stored in a database connectable to the server.

20. A method for creating and identifying a plurality of unambiguously identified resources based on an initial resource, comprising the steps of:
receiving by a computing device an initial resource including an at-least-relative URI;
converting the initial resource into at least one final resource comprising at least one of the group of a MIME type, a user agent identifier, and a user locale;
for each of the at least one final resources, creating a URI identifying the resource based on at least:
the at-least-relative URI; and
the at least one of the group of a MIME type, a user agent identifier, and a user locale.

21. The method of claim 20,
wherein the step of converting comprises converting the initial resource into at least one final resource comprising at least two of the group of a MIME type, a user agent identifier, and a user locale; and
wherein the step of creating comprises creating a URI identifying the resource based on at least:
the at-least-relative URI; and
the at least two of the group of a MIME type, a user agent identifier, and a user locale.

22. The method of claim 20,
wherein the step of converting comprises converting the initial resource into at least one final resource comprising a MIME type, a user agent identifier, and a user locale; and
wherein the step of creating comprises creating a URI identifying the resource based on at least:
the at-least-relative URI; and
the MIME type;
the user agent identifier; and
the user locale.

23. The method of claim 22, wherein the initial resource is in XML format.
